(19) United States
(12) Patent Application Publication
(10) Pub. No.: US 2023/0335841 A1
(43) Pub. Date: Oct. 19, 2023

(54) BATTERY PACK AND UNMANNED AERIAL VEHICLE

(71) Applicant: Dongguan Poweramp Technology Limited, Dongguan City (CN)

(72) Inventors: Guoqing Xu, Dongguan City (CN); Chunhua Bian, Dongguan City (CN)

(73) Assignee: Dongguan Poweramp Technology Limited, Dongguan City (CN)

(21) Appl. No.: 18/212,795

(22) Filed: Jun. 22, 2023

Related U.S. Application Data
(63) Continuation of application No. PCT/CN2020/138808, filed on Dec. 24, 2020.

(51) Int. Cl. H01M 50/249; H01M 50/209; H01M 10/6551

(52) U.S. Cl. CPC H01M 50/209; H01M 10/6551; H01M 50/249; H01M 2220/20

(57) ABSTRACT

A battery pack includes a housing, a battery module, and a resin layer. At least one side of the housing is provided with a through-hole. The battery module is accommodated in an accommodation cavity formed by the housing. The resin layer is disposed on a lower part of a side end of the battery module, and covers package parts of side ends of all cells. The side end of the battery module is the side ends of the plurality of cells in the battery module, and a channel is disposed between the through-hole and a space enclosed by the resin layer and the battery module. Based on this, this application can protect the package parts, and avoid corrosion of exposed metal at the package parts. Moreover, the resin layer can conduct, to the outside through the through-hole, heat produced by the cells, thereby facilitating heat dissipation.

### CROSS REFERENCE TO THE RELATED APPLICATIONS

This application is a continuation application of International Application No. PCT/CN2020/138808, filed on Dec. 24, 2020, the contents of which is incorporated herein by reference in its entirety.

### TECHNICAL FIELD

This application relates to the field of battery technologies, and specifically, to a battery pack and an unmanned aerial vehicle.

### BACKGROUND

Soft-packed cells have performance advantages such as light weight, flexible size design, and high energy density, and have been widely used for electronic devices such as mobile communications devices, electric tools, and unmanned aerial vehicles. A working voltage interval of a single soft-packed cell (also referred to as a pouch cell), for example, a soft-packed lithium-ion battery, is generally between 2 V and 5 V. For a product field that requires relatively high power, soft-packed cells usually need to be connected in series or in parallel to constitute a battery pack, so as to increase an output voltage and current. In this way, charging and discharging power of an entire battery system is increased, thereby meeting an actual application requirement.

Due to characteristics of a structure of the soft-packed cell, safety protection for the soft-packed cell is not sufficiently comprehensive. For example, protection for a package part of the soft-packed cell is insufficient, leading to corrosion of exposed metal at the package part of the soft-packed cell. This brings a relatively high safety risk.

Protection for a package part of a soft-packed cell is insufficient.

### SUMMARY

A first aspect of this application provides a battery pack, including a housing, a battery module, and a resin layer. At least one side of the housing is provided with a through-hole. The battery module is accommodated in an accommodation cavity formed by the housing, and the battery module includes a plurality of cells. The resin layer is disposed in a partial region of a side end of the battery module, and covers package parts of side ends of the plurality of cells. The partial region includes a lower part of the side end of the battery module, the side end of the battery module is an end at which the side ends of the plurality of cells in the battery module are located, and a channel is disposed between the through-hole and a space enclosed by the resin layer and the battery module.

A height of the resin layer is less than or equal to ⅔ of that of the side end of the battery module, one end of the resin layer is connected to bottoms of the plurality of cells, and the height of the resin layer is a distance between an other end opposite to the one end of the resin layer and a bottom of the battery module.

A height of the resin layer is less than or equal to ½ of that of the side end of the battery module, one end of the resin layer is connected to bottoms of the plurality of cells, and the height of the resin layer is a distance between an other end opposite to the one end of the resin layer and a bottom of the battery module.

A height of the resin layer is less than or equal to ⅓ of that of the side end of the battery module, one end of the resin layer is connected to bottoms of the plurality of cells, and the height of the resin layer is a distance between an other end opposite to the one end of the resin layer and a bottom of the battery module.

A height of the resin layer is greater than ⅓ of that of the side end of the battery module and less than or equal to a length of the side end of the battery module, one end of the resin layer is connected to bottoms of the plurality of cells, and the height of the resin layer is a distance between an other end opposite to the one end of the resin layer and a bottom of the battery module.

The resin layer includes a plurality of sublayers disposed at an interval, each of the sublayers covers a partial region of a side end of each cell, the partial region of the side end of the cell includes a lower part of the side end of the cell, and each of the sublayers covers a package part of a side end of each cell.

The at least one side provided with the through-hole is a bottom face or a side face of the housing.

The bottom face of the housing is provided with a plurality of through-holes, and the channel is disposed between the plurality of through-holes and the plurality of cells in the battery module.

Some or all of the plurality of through-holes are disposed between adjacent cells, and the channel is disposed between the some or all of the plurality of through-holes and the adjacent cells. The heat conduction channel is formed between the plurality of through-holes and the cells and between the plurality of through-holes and the adjacent cells, so that heat produced by the cells can be conducted to the outside through the plurality of through-holes. This helps to reduce heat of the cells.

The resin layer is further disposed in a partial region between adjacent cells.

A minimum width of the resin layer between two adjacent cells ranges between 5 mm and 10 mm.

In a direction from top to bottom of the battery module, a width of the resin layer between two adjacent cells remains unchanged or gradually increases.

A bottom of the housing is provided with a cushion pad, and the plurality of cells are disposed on the cushion pad.

An inner wall of the housing is covered with fire-retardant insulation paper.

A second aspect of this application provides an unmanned aerial vehicle, including the battery pack according to any one of the foregoing designs.

### Beneficial Effects

In this application, the resin layer is disposed on the side end of the battery module, and the resin layer covers and protects the package parts of all the cells, so as to avoid corrosion of exposed metal at the package parts, and reduce a safety risk. In addition, the heat conduction channel is formed between the resin layer and the outside through the through-hole disposed in the housing. Heat produced by the cells can be transferred to the resin layer and dissipated by using the resin layer. This helps to reduce heat of the cells, and can reduce a safety risk caused by overheat of the cells.

Moreover, the resin layer covers the package parts of all the cells, but does not completely cover the side end of the battery module, and therefore, a potting region is small. This helps to reduce a weight of dispensed glue, thereby reducing a weight of the battery pack.

Further optionally, the resin layer is further dispensed in a partial region between two adjacent cells, thereby increasing a contact area between the resin layer and the cells. This can improve a support and fixing effect for the cells, and further improve sealing and safety protection effects for the package parts.

### BRIEF DESCRIPTION OF DRAWINGS

FIG. 1 is a schematic structural diagram of a battery pack according to a first embodiment of this application;

FIG. 2 is a schematic structural diagram of a bottom face of a battery pack according to an embodiment of this application;

FIG. 3 is a partial cross-sectional view in an A-A direction of the battery pack shown in FIG. 1;

FIG. 4 is an enlarged schematic structural diagram of a dashed-line limited region shown in FIG. 3;

FIG. 5 is a schematic structural diagram of a battery pack according to a second embodiment of this application;

FIG. 6 is a schematic structural diagram of a battery pack according to a third embodiment of this application;

FIG. 7 is a partial cross-sectional view in an A-A direction of the battery pack shown in FIG. 6;

FIG. 8 is an enlarged schematic structural diagram of a dashed-line limited region shown in FIG. 7; and

FIG. 9 is a schematic structural diagram of a battery pack according to a fourth embodiment of this application.

### DETAILED DESCRIPTION

To make the objectives, technical solutions, and advantages of this application clearer, the following clearly describes the technical solutions of this application with reference to specific some embodiments and corresponding accompanying drawings. Apparently, the described some embodiments are merely some rather than all of the embodiments of this application. The following some embodiments and technical features thereof may be combined if there is no collision.

It should be understood that, in descriptions of some embodiments of this application, directions or location relationships indicated by the terms such as “center”, “longitudinal”, “lateral”, “length”, “width”, “thickness”, “up”, “down”, “front”, “rear”, “left”, “right”, “vertical”, “horizontal”, “top”, “bottom”, “inside”, “outside”, “clockwise”, and “counterclockwise” are directions or location relationships based on what is shown in the accompanying drawings, and are merely intended to describe the technical solutions in the corresponding some embodiments of this application and simplify the descriptions, but are not intended to indicate or imply that an apparatus or an element need to have a specific direction or be constructed and operated in a specific direction; therefore, such directions or location relationships shall not be construed as a limitation on this application.

In consideration of a problem that protection for a package part of a soft-packed cell is insufficient in the prior art, some embodiments of this application provide a battery back, where a resin layer is disposed on a side end of a battery module. The resin layer covers and protects package parts of all cells, but does not completely cover the side end of the battery module. This not only avoids corrosion of exposed metal at the package parts of the cells, but also helps to reduce a weight of dispensed glue because a potting region is small. In addition, a channel is formed between the resin layer and the battery module and a through-hole, thereby facilitating heat dissipation for the cells.

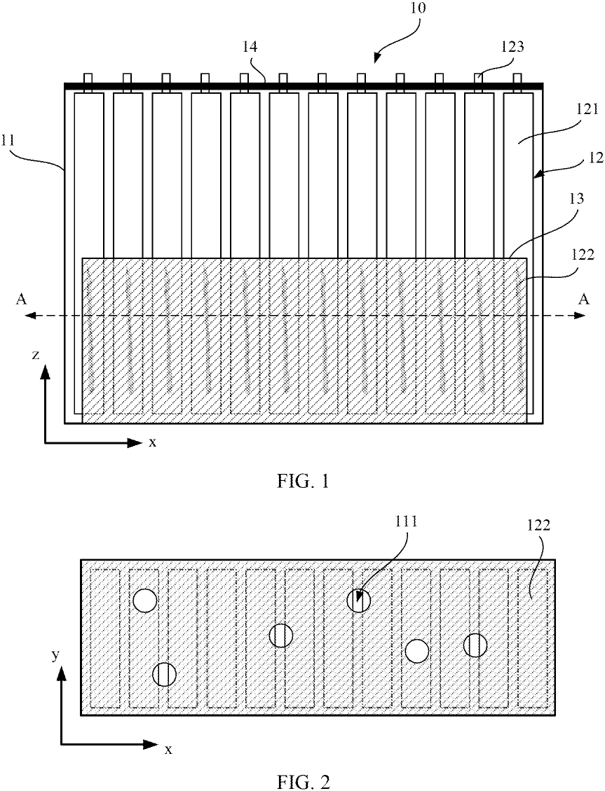

FIG. 1 is a schematic structural diagram of a battery pack according to an embodiment of this application. Referring to FIG. 1, the battery pack 10 includes a housing 11, a battery module 12, and a resin layer 13.

The housing 11 forms a shape of the battery pack 10 through enclosure, and limits an appearance of the battery pack 10. The housing 11 forms a cell compartment used as an accommodation cavity of the housing 11. Internal elements (for example, plurality of cells 121) of the battery pack 10 are built into the cell compartment, so as to protect components in the battery pack 10 by using the housing 11. This can improve a protection effect for the battery module 12, and ensure safety of the battery pack 10.

The battery module 12 includes the plurality of cells 121, and is accommodated in the accommodation cavity of the housing 11. A quantity of the cells 121 may depend on an electricity quantity design requirement of the battery pack 10, and is not limited in this specification. These cells 121 are sequentially accommodated at an interval in the cell compartment of the housing 11, for example, sequentially disposed at an interval in the cell compartment along a first direction x indicated by an arrow in FIG. 1.

These cells 121 are connected in series or in parallel to constitute an effective power supply and/or charging unit of the battery pack 10. These cells 121 include but are not limited to soft-packed cells, and may have an identical structure. In some descriptions in this specification, a single cell 121 is used as an example for description.

One end (an upper end shown in FIG. 1) of each cell 121 has tabs 123, including a positive electrode tab and a negative electrode tab. The battery pack 10 further includes a tab board 14. The tabs 123 of the cell 121 are connected to the tab board 14, for example, may be connected to the tab board 14 through welding.

For soft-packed cells 121, each cell 121 has a package part 122 located at a side end of the cell 121. Side ends of the cells 121 are adjacent to an inner wall of the housing 11, and the side ends of the cells 121 are opposite the inner wall of the housing 11 at an interval from the inner wall. Therefore, there is a potting region between the side ends of the cells 121 and the inner wall of the housing 11. Package parts 122 of the cells 121 are located in the potting region.

The resin layer 13 is disposed between the inner wall of the housing 11 and the side ends of the plurality of cells 121, but does not fill the entire potting region. Specifically, each package part 122 is located at a lower part of each cell 121, and therefore, the resin layer 13 covers lower parts of the side ends of the plurality of cells 121 and covers the package parts 122 of all the cells 121.

It should be understood that, if the package part 122 is at a different location on the cell 121, a location covered with the resin layer 13 is also different. To sum up, the resin layer 13 is disposed in a partial region of a side end of the battery module 12, and the partial region includes a lower part of the side end of the battery module 12, so that the resin layer 13 covers the package parts 122 of all the cells 121. In this way, the package parts 122 can also be protected.

For example, as shown in FIG. 1, the resin layer 13 is disposed on the lower part of the side end of the battery module 12, and a height of the resin layer 13 is equal to ½ of that of the side end of the battery module 12. One end of the resin layer 13 is connected to bottoms of the plurality of cells 121. The height of the resin layer is a distance between an other end opposite to the one end of the resin layer 13 and a bottom of the battery module 12. The side end of the battery module 12 is an end at which the side ends of the plurality of cells 121 in the battery module 12 are located. Certainly, a height of the resin layer 13 may be alternatively greater than ½ of that of the side end of the battery module 12.

For another example, the resin layer 13 is disposed on the lower part of the side end of the battery module 12, and a height of the resin layer 13 is greater than or equal to ⅓ or ⅔ of that of the side end of the battery module 12.

For still another example, the resin layer 13 is disposed on the lower part of the side end of the battery module 12, and a height of the resin layer 13 is greater than ⅓ of that of the side end of the battery module 12 and less than or equal to a length of the side end of the battery module 12. The length is a size in a second direction y shown in FIG. 2.

Alternatively, based on the descriptions of FIG. 1, the resin layer 13 further includes another part. The another part may be disposed at an interval from the resin layer 13 that is disposed on the lower part of the side end of the battery module 12 and that is shown in FIG. 1, and may be disposed on an upper part and/or a middle part of the side end of the battery module 12. In addition, the another part may have a structure the same as that of the resin layer 13 described in FIG. 1.

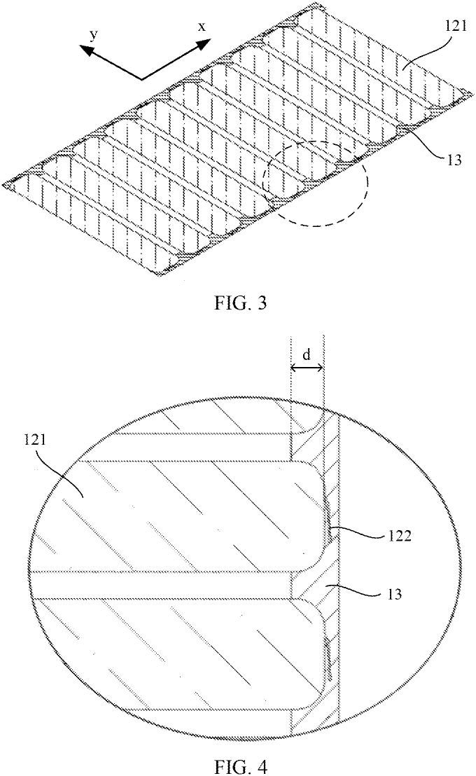

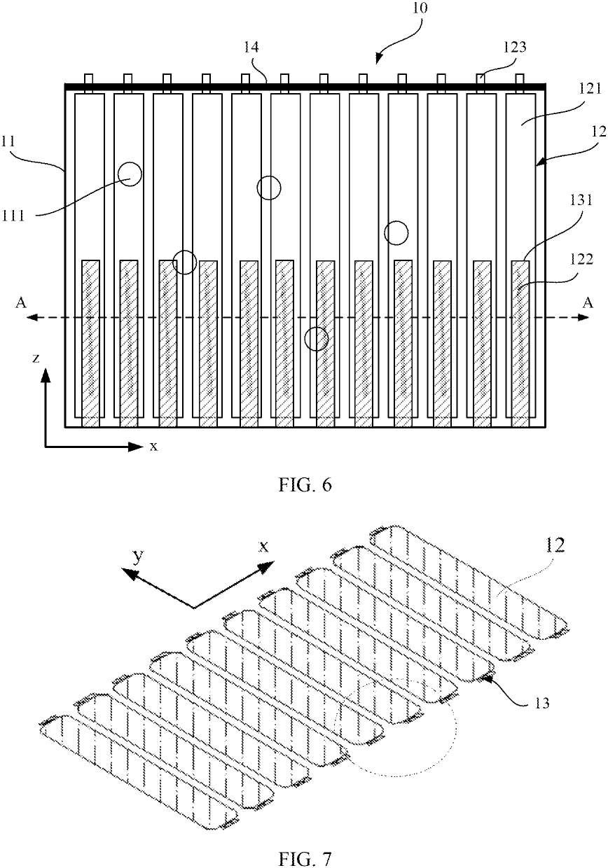

In an implementation shown in FIG. 1 and FIG. 3, the resin layer 13 may be strip-shaped. In a direction from top to bottom of the cell compartment (that is, in a third direction z indicated by an arrow in FIG. 1), a size of the resin layer 13 is less than a size of the cell 121. Compared with a resin layer constituted by a plurality of sub-bodies 131 shown in FIG. 6 below, the strip-shaped resin layer 13 has a large area and partially covers a region between adjacent cells 121, thereby helping to improve positioning stability of the cells 121 in the cell compartment.

To further reduce a weight of the resin layer 13, in a direction along which the plurality of cells 121 are arranged at an interval (that is, in the first direction x indicated by the arrow in FIG. 1), a size of the strip-shaped resin layer 13 is less than a size occupied by all the cells 121. The size occupied by all the cells 121 is a sum of sizes of all the cells 121 and a size between the adjacent cells 121.

For a cell 121 packed by using a soft pack technology, for example, a lithium-ion battery, a metal composite film (for example, an aluminum composite film) is usually used for outer packing of internal composition (including a positive electrode, a negative electrode, a separator, and an electrolyte). Metal is exposed on a package edge of the metal composite film, that is, the package part 122 of the cell 121. If the metal is exposed to an external environment for a long time, a short circuit is easily caused; or if the metal is exposed to a flowing corrosive environment such as a salt fog or an acid/alkaline aqueous solution, the metal composite film is easily corroded, leading to failure of the battery packing. In some embodiment of this application, the resin layer 13 wraps only the package part 122 of each cell 121 rather than completely covering the side end of each cell 121. According to such a design, the package parts 122 of all the cells 121 can be protected, so that corrosion of (metal composite films of) the package parts 122 is avoided, thereby implementing safety protection for the side ends of the cells 121 and reducing a safety risk; moreover, a potting region is small, thereby helping to reduce a weight of dispensed glue, so as to reduce an overall weight of the battery pack 10. In addition, the resin layer 13 is a cured gel, the chemical and physical characteristics of the resin layer 13 are relatively stable, and therefore has high reliability.

Further, the resin layer 13 may have a function of conducting heat. In other words, the resin layer 13 may be a resin with a heat conduction function. Therefore, as the resin layer 13 is in contact with each cell 121, a channel (also referred to as a heat conduction channel) can be formed between the resin layer 13 and the cell 121. Heat produced by the cell 121 can be transferred to the resin layer 13 and dissipated by using the resin layer 13. This helps to reduce heat of the cell 121, and can reduce a safety risk caused by overheat of the cell 121.

At least one side of the housing 11 is provided with one or more through-holes 111. In an implementation, referring to FIG. 1 and FIG. 2, a bottom face of the housing 11 is provided with a plurality of through-holes 111. A quantity of through-holes 111 and a size, shape, and location of the through-hole 111 may be set based on an actual requirement. For example, as shown in FIG. 2, a single through-hole 111 may expose only a cell 121, or a single through-hole 111 exposes both a part of a cell 121 and a region between adjacent cells 121, so that a channel is formed between the through-hole 111 and a space enclosed by the resin layer 13 and the battery module 12. The resin layer 13 can conduct, to the outside through the through-hole 111, heat produced by the cell 121, and the heat produced by the cell 121 can also be directly conducted to the outside through the through-hole 111. This facilitates heat dissipation. Alternatively, the battery pack 10 is placed in a low-temperature medium such as water, and the low-temperature medium enters a region between adjacent cells 121 through a through-hole 111, and contacts all the cells 121 and the resin layer 13, thereby helping to reduce heat of the cells 121, and reduce a safety risk caused by overheat of the cells 121.

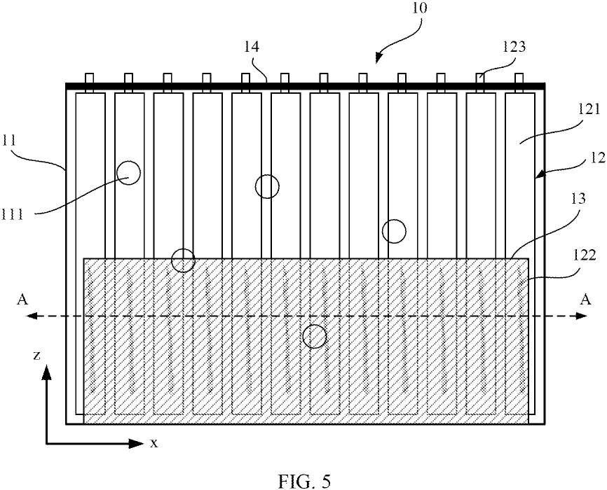

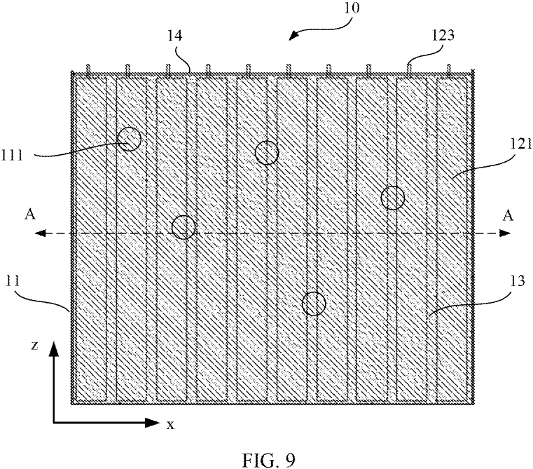

In another implementation, referring to FIG. 5, FIG. 6, and FIG. 9, a side face of the housing 11 is provided with a plurality of through-holes 111. A single through-hole 111 may expose only a cell 121, or a single through-hole 111 exposes both a part of a cell 121 and a region between adjacent cells 121, or a single through-hole 111 exposes a cell 121, a region between adjacent cells 121, and the resin layer 13. In this way, a channel is formed between the through-hole 111 and space enclosed by the resin layer 13 and the battery module 12. The resin layer 13 can conduct, to the outside through the through-hole 111, heat produced by the cell 121, and the heat produced by the cell 121 can also be directly conducted to the outside through the through-hole 111. This facilitates heat dissipation. When the battery pack 10 is placed in a low-temperature medium such as water, a through-hole 111 disposed on a lower part of the housing 11 can allow the low-temperature medium to enter a region between adjacent cells 121 and contact all the cells 121 and the resin layer 13, thereby helping to reduce heat of the cells 121.

In still another implementation, both a bottom face and side face of the housing 11 may be provided with through-holes 111.

Referring to FIG. 3 and FIG. 4, the resin layer 13 is dispensed on two opposite side ends of each cell 121, and is disposed in a partial region between adjacent cells 121. In other words, the resin layer 13 covers the package part 122 (a right side end in FIG. 4) of each cell 121, and is also disposed between adjacent cells 121. In this state, the resin layer 13 covers a partial right side end of the cell 121 and a partial upper side end and a partial lower side end that adjoin the right side end.

For ease of description, in this specification, a part, of the resin layer 13, disposed between adjacent cells 121 in FIG. 3 is referred to as a part, of the resin layer 13, disposed in a main body of the battery pack 10. The main body of the battery pack 10 is the cells 121. The resin layer 13 does not fill the entire main body of the battery pack 10.

The resin layer 13 is disposed between adjacent cells 121, thereby increasing a contact area between the resin layer 13 and the cells 121. This can improve a support and fixing effect for the cells 121, and further improve sealing and safety protection effects for the package parts 122 of the cells 121.

In an implementation, in the direction from top to bottom of the cell compartment, that is, in the third direction z indicated by the arrow in FIG. 1, a width d of the resin layer 13 between two adjacent cells 121 remains unchanged. The width d is a size of the resin layer 13 in a second direction y indicated by an arrow in FIG. 3.

It should be understood that a preparation manner of the resin layer 13 is not limited in this application, and a person of ordinary skill in the art may adopt a suitable process based on an actual requirement. For example, based on an implementation process, in the direction from top to bottom of the cell compartment, that is, in the third direction z indicated by the arrow in FIG. 1, a width of the resin layer 13 between two adjacent cells 121 gradually increases.

Referring to FIG. 4, the width d of the resin layer 13 between two adjacent cells 121 may be adaptively set based on an actual requirement (for example, a size of the battery pack 10). The width d is not limited in this embodiment of this application, on the premise that support and fixing and safety protection for the cells 121 meet requirements. For example, for lithium-ion soft-packed cells 121 commonly used in the industry, a minimum width d of the resin layer 13 between two adjacent cells 121 may range between 5 mm and 10 mm.

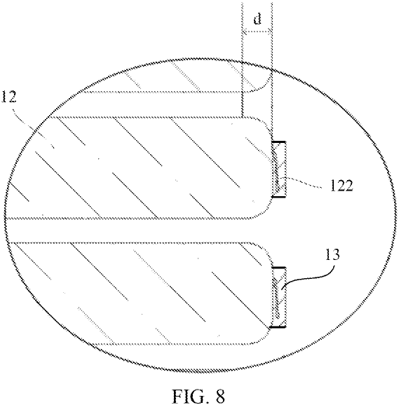

This application further provides a glue dispensing design according to another embodiment. For ease of comparative description, structural elements with same numeral identifiers and same names are used in this specification. FIG. 6 is a schematic structural diagram of a battery pack according to another embodiment of this application. Referring to FIG. 6, FIG. 7, and FIG. 8, the resin layer 13 includes a plurality of sublayers 131 disposed at an interval, a quantity of the sublayers 131 is equal to a quantity of the cells 121, each sublayer 131 may be block-shaped, a size of each sublayer 131 is slightly greater than an orthographic projection area of a package part 122 on a side end of a cell 121, each sublayer 131 covers a lower part of a side end of one cell 121, and each sublayer 131 covers a package part 122 of one cell 121.

Therefore, the resin layer 13 covers lower parts of the side ends of the plurality of cells 121, and covers the package parts 122 of all the cells 121. In this way, the package parts 122 of all the cells 121 can be protected, so that corrosion of exposed metal at the package parts 122 is avoided, thereby reducing a safety risk; moreover, a potting region is small, thereby helping to reduce a weight of dispensed glue, so as to reduce a weight of the battery pack 10.

It should be understood that, if a location of the package part 122 of each cell 121 is different, a location covered with each sublayer 131 is also different. In this embodiment, all the sublayers 131 are disposed in a partial region of the side end of the battery module 12, and the partial region includes the lower part of the side end of the battery module 12, so that all the sublayers 131 of the resin layer 13 cover the package parts 122 of all the cells 121. In this way, the package parts 122 can also be protected.

This application further provides a glue dispensing design according to still another embodiment. Referring to FIG. 9, the resin layer 13 may be sheet-shaped, and completely cover the side ends of the plurality of cells 121. This may be considered as the following: The resin layer 13 is dispensed on the entire side ends of the plurality of cells 121, and therefore, the resin layer 13 also completely covers the package parts 122 of all the cells 121. In this way, the package parts 122 of all the cells 121 can also be protected, so that corrosion of exposed metal at the package parts 122 is avoided, thereby reducing a safety risk.

For the embodiments described in FIG. 1 to FIG. 4, the embodiment described in FIG. 5, the embodiments described in FIG. 6 to FIG. 8, and the embodiment shown in FIG. 9, technical features of some embodiments may be combined if there is no collision. For example, the resin layer 13 in the embodiment described in FIG. 9 may be alternatively disposed in a part between adjacent cells 121, that is, disposed in a main-body part of the battery pack 10. In addition, this application further provides another design for the battery pack 10 according to any embodiment. Refer to the following descriptions.

In the first direction x indicated by the arrow in FIG. 1, each of two outermost cells 121, namely, the first cell 121 and the last cell 121, is opposite a compartment wall of the cell compartment adjacent to the outermost cell 121, and is disposed at an interval from the adjacent compartment wall, so that there is a potting region between each of the two outermost cells 121 and a compartment wall adjacent to the outermost cell 121. The resin layer 13 may be further disposed in the potting region.

Based on this, an overall contact area between the resin layer 13 and the cells 121 is increased, thereby further improving support and fixing and safety protection effects for the cells 121.

Certainly, alternatively, the resin layer 13 may not be disposed between the two outermost cells 121 and compartment walls of the cell compartment that are respectively adjacent to the outermost cells 121; in this region, a part of the resin layer 13 disposed in the main body of the battery pack 10 is the same as that between two adjacent cells 121.

A compartment bottom of the cell compartment, that is, a bottom of the housing 11, may be provided with a cushion pad (which is not shown in FIG. 1), and the foregoing cells 121 are disposed on the cushion pad. When the battery pack 10 is used in a scenario such as an electric car or an electric bicycle, vibration is relatively violent during use, and the cushion pad can alleviate vibration of the cells 121, thereby helping to increase a safety coefficient of the cells 121.

An inner wall of the housing 11 may be covered with fire-retardant insulation paper, which is specifically located between the resin layer 13 and the inner wall. The fire-retardant insulation paper can control a risk caused by the cell 121 catching fire, and can also insulate the internal cells 121 from impact of external fire, thereby protecting the battery pack 10.

This application further provides an unmanned aerial vehicle. The unmanned aerial vehicle includes the battery pack 10 according to any one of the foregoing embodiments, and therefore has beneficial effects that can be achieved by the battery pack 10.

Another embodiment of this application provides an electronic device, and the electronic device includes the battery pack 10 according to any one of the foregoing embodiments. The electronic device may be implemented in various specific forms. For example, in actual application scenarios, the electronic device includes but is not limited to electronic products such as an electric tool, an electric vehicle, an energy storage product, an electric bicycle, and an electric navigation tool.

It can be understood by a person skilled in the art that the construction according to some embodiments of this application can also be applied to fixed electronic devices in addition to elements specially used for mobile purposes.

Because the electronic device has the battery pack 10 according to any one of the foregoing embodiments, the electronic device can produce beneficial effects of the battery pack 10 according to the corresponding embodiment.

The foregoing descriptions are merely some embodiments of this application, but are not intended to limit the patent scope of this application. Any equivalent structural transformations made by using the content of this specification and the accompanying drawings are also included in the patent protection scope of this application.

Without more restrictions, an element defined by the statement “including a...” does not exclude existence of other same elements in a process, a method, an article, or an apparatus that includes the element. In addition, in different embodiments, components, features, or elements with a same name may have a same meaning or different meanings, and their specific meanings need to be determined based on their interpretations in the specific some embodiments or further with reference to the context in the specific embodiments.

In addition, as used in this specification, singular forms “a”, “an”, and “the” are intended to also include plural forms. The terms “or” and “and/or” are interpreted as inclusive, or mean any one or any combination. An exception to this definition occurs only when a combination of elements, functions, steps, or operations is inherently mutually exclusive in some ways.

We claim:

1. A battery pack, comprising:
a housing, wherein at least one side of the housing is provided with a through-hole;
a battery module, accommodated in an accommodation cavity formed by the housing, wherein the battery module comprises a plurality of cells; and
a resin layer, disposed in a partial region of a side end of the battery module, and covering package parts of side ends of the plurality of cells, wherein the partial region comprises a lower part of the side end of the battery module, the side end of the battery module is an end at which the side ends of the plurality of cells in the battery module are located, and a channel is disposed between the through-hole and a space enclosed by the resin layer and the battery module.

2. The battery pack according to claim 1, wherein a height of the resin layer is less than or equal to ⅔ of a height of the side end of the battery module, one end of the resin layer is connected to bottoms of the plurality of cells, and the height of the resin layer is a distance between an other end opposite to the one end of the resin layer and a bottom of the battery module.

3. The battery pack according to claim 2, wherein the height of the resin layer is less than or equal to ½ of the height of the side end of the battery module.

4. The battery pack according to claim 3, wherein the height of the resin layer is less than or equal to ⅓ of the height of the side end of the battery module.

5. The battery pack according to claim 1, wherein a height of the resin layer is greater than ⅓ of a height of the side end of the battery module and less than or equal to a length of the side end of the battery module, one end of the resin layer is connected to bottoms of the plurality of cells, and the height of the resin layer is a distance between an other end opposite to the one end of the resin layer and a bottom of the battery module.

6. The battery pack according to claim 1, wherein the resin layer comprises a plurality of sublayers disposed at an interval, each of the sublayers covers a partial region of a side end of each cell, the partial region of the side end of the cell comprises a lower part of the side end of the cell, and each of the sublayers covers a package part of the side end of each cell.

7. The battery pack according to claim 1, wherein the at least one side provided with the through-hole is a bottom face or a side face of the housing.

8. The battery pack according to claim 7, wherein the bottom face of the housing is provided with a plurality of through-holes, and the channel is disposed between the plurality of through-holes and the plurality of cells in the battery module.

9. The battery pack according to claim 8, wherein some or all of the plurality of through-holes are disposed between adjacent cells, and the channel is disposed between the some or all of the plurality of through-holes and the adjacent cells.

10. The battery pack according to claim 1, wherein the resin layer is further disposed in a partial region between adjacent cells.

11. The battery pack according to claim 10, wherein a minimum width of the resin layer between two adjacent cells ranges between 5 mm and 10 mm.

12. The battery pack according to claim 10, wherein in a direction from top to bottom of the battery module, a width of the resin layer between two adjacent cells remains unchanged or gradually increases.

13. The battery pack according to claim 1, wherein a bottom of the housing is provided with a cushion pad, and the plurality of cells are disposed on the cushion pad.

14. The battery pack according to claim 1, the cell is a soft-packed cell.

15. An unmanned aerial vehicle, comprising a battery pack, wherein the battery pack comprises:
a housing, wherein at least one side of the housing is provided with a through-hole;
a battery module, accommodated in an accommodation cavity formed by the housing, wherein the battery module comprises plurality of cells; and
a resin layer, disposed in a partial region of a side end of the battery module, and covering package parts of side ends of the plurality of cells, wherein the partial region comprises a lower part of the side end of the battery module, the side end of the battery module is an end at which the side ends of the plurality of cells in the battery module are located, and a channel is disposed between the through-hole and a space enclosed by the resin layer and the battery module.

16. The unmanned aerial vehicle according to claim 15, wherein a height of the resin layer is less than or equal to ⅔ of a height of the side end of the battery module, or the height of the resin layer is less than or equal to ½ of the height of the side end of the battery module, or the height of the resin layer is less than or equal to ⅓ of the height of the side end of the battery module, or the height of the resin layer is greater than ⅓ of a height of the side end of the battery module and less than or equal to a length of the side end of the battery module, one end of the resin layer is connected to bottoms of the plurality of cells, and the height of the resin layer is a distance between the other end opposite the one end of the resin layer and a bottom of the battery module.

17. The unmanned aerial vehicle according to claim 15, wherein the resin layer comprises a plurality of sublayers disposed at an interval, each of the sublayers covers a partial region of a side end of each cell, the partial region of the side end of the cell comprises a lower part of the side end of the cell, and each of the sublayers covers a package part of a side end of each cell.

18. The unmanned aerial vehicle according to claim 17, wherein a bottom face of the housing is provided with a plurality of through-holes, and the channel is disposed between the plurality of through-holes and the cells in the battery module.

19. The unmanned aerial vehicle according to claim 15, wherein the resin layer is further disposed in a partial region between adjacent cells.

20. The unmanned aerial vehicle according to claim 15, the cell is soft-packed cell.
